(19) United States
(12) Patent Application Publication
(10) Pub. No.: US 2016/0241553 A1
(43) Pub. Date: Aug. 18, 2016

(54) WEARABLE DEVICE AND OPERATING METHOD THEREOF

(71) Applicant: SAMSUNG ELECTRONICS CO., LTD., Suwon-si (KR)

(72) Inventor: Hyun-tae KIM, Seoul (KR)

(21) Appl. No.: 15/002,540

(22) Filed: Jan. 21, 2016

(30) Foreign Application Priority Data
Feb. 17, 2015 (KR) 10-2015-0024161

(51) Int. Cl. H04L 29/06; H04L 12/28; H04W 12/06; H04L 29/08

(52) U.S. Cl. CPC H04L 63/0861; H04L 67/125; H04L 12/282; H04W 12/06; H04L 2012/2841

(57) ABSTRACT

A wearable device is provided. The wearable device including a sensor configured to detect a wearing state of the wearable device and to obtain authentication information of a user and at least one piece of biometric information, and a processor configured to authenticate the user based on the obtained authentication information when the wearing state of the wearable device is detected by the sensor to indicate that the wearable device is being worn, and configured to activate at least one function of the wearable device based on the obtained biometric information.

### CROSS-REFERENCE TO RELATED APPLICATION

This application is based on and claims priority under 35 U.S.C. §119 to Korean Patent Application No. 10-2015-0024161, filed on Feb. 17, 2015, in the Korean Intellectual Property Office, the disclosure of which is incorporated by reference herein in its entirety.

### BACKGROUND

1. Field

The present disclosure relates to wearable devices and operating methods thereof.

2. Description of Related Art

A wearable device is a device that may be attached to a user's body and may perform a computing operation. Wearable devices may be implemented in various forms, such as, for example, a watch or glasses, which are attachable to a user's body.

### SUMMARY

Wearable devices and operating methods thereof are provided and are capable of saving electric power and easily activating prescribed functions.

Additional aspects will be set forth in part in the description which follows and, in part, will be apparent from the description.

According to an aspect of an example embodiment, a wearable device includes a sensor configured to detect a wearing state of a wearable device and to obtain authentication information and at least one piece of biometric information, and a processor configured to authenticate a user based on the obtained authentication information when the wearing state of the wearable device is detected by the sensor, and configured to activate at least one function of the wearable device based on the obtained biometric information.

In the above-described wearable device, the sensor may be configured to further obtain at least one piece of environment information, and the processor may be configured to activate at least one function based on the obtained biometric information and the environment information.

In the above-described wearable device, the sensor may include a first sensor configured to detect the wearing state of the wearable device, a second sensor configured to obtain the authentication information by being activated when the wearing state of the wearable device is detected, and a third sensor configured to obtain the biometric information by being activated when the user is authenticated.

In the above-described wearable device, at least one of the first to third sensors may be deactivated when the at least one function is activated.

In the above-described wearable device, the at least one function may include a function of controlling a home network environment.

According to another aspect of the example embodiment, the wearable device may include an input unit comprising input circuitry, the input unit configured to receive an input, the input setting the at least one function to be activated.

In the above-described wearable device, the input unit may further be configured to receive an input, the input setting a condition of the biometric information to activate the at least one function.

In the above-described wearable device, the wearable device may include a watch-type wearable device, and the sensor may be configured to detect a wearing state of the watch-type wearable device based on whether or not a fastener located on a watch band is fastened.

In the above-described wearable device, the wearable device may include a glasses-type wearable device, and the sensor may be configured to detect a wearing state of the glasses-type wearable device based on at least one of pressure applied to nose pads, a temple, a bridge, a rim, a tip of the glasses-type wearable device and an angle between the rim and the temple.

In the above-described wearable device, the wearable device may include a band-type wearable device, and the sensor may be configured to detect a wearing state of the band-type wearable device based on pressure applied to a band of the band-type wearable device.

According to an aspect of another example embodiment, a method of operating a wearable device includes detecting a wearing state of a wearable device, obtaining authentication information and authenticating when the wearing state of the wearable device is detected, obtaining at least one piece of biometric information of a user when the user is authenticated, and activating at least one function of the wearable device based on the obtained biometric information.

According to another aspect of the example embodiment, the method of operating the wearable device may further include obtaining at least one piece of environment information, and the activating of the at least one function includes activating the at least one function based on the obtained biometric information and the environment information.

In the above-described operating method, the at least one function may include a function of controlling a home network environment.

According to another aspect of the example embodiment, the method of operating the wearable device may further include receiving an input, the input setting the at least one function to be activated.

According to another aspect of the example embodiment, the method of operating the wearable device may further include receiving an input, the input setting a condition of the biometric information to activate the at least one function.

In the above-described operating method, the wearable device may include a watch-type wearable device, and the detecting of the wearing state of the wearable device may include detecting a wearing state of the watch-type wearable device based on whether or not a fastener located on a watch band is fastened.

In the above-described operating method, the wearable device may include a glasses-type wearable device, and the detecting the wearing state of the wearable device may detect a wearing state of the glasses-type wearable device based on at least one of pressure applied to nose pads, a temple, a bridge, a rim, a tip of the glasses-type wearable device and an angle between the rim and the temple.

In the above-described operating method, the wearable device may include a band-type wearable device, and the detecting of the wearing state of the wearable device may include detecting a wearing state of the band-type wearable device based on pressure applied to a band.

A non-transitory computer-readable recording medium according to some example embodiments may have recorded thereon a program for executing the method of the example embodiments.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a diagram illustrating an example operation of a watch-type wearable device;

FIG. 2 is a flowchart illustrating an example operation of a wearable device;

FIG. 3 is a flowchart illustrating an example operation of setting a function to be activated in a wearable device and a condition of biometric information;

FIG. 4 is a flowchart illustrating an example operation of activating a wireless communication function by obtaining a pulse of a user, performed by a wearable device;

FIG. 5 is a diagram illustrating an example operation of activating at least one function by obtaining biometric information, performed by a watch-type wearable device;

FIG. 6 is a diagram illustrating an example operation of setting a function to be activated in a watch-type wearable device and a condition of biometric information;

FIG. 7 is a diagram illustrating an example structure of a watch-type wearable device;

FIG. 8 is a diagram illustrating an example operation of a glasses-type wearable device;

FIG. 9 is a diagram illustrating an example operation of activating at least one function by obtaining biometric information, performed by a glasses-type wearable device;

FIG. 10 is a diagram illustrating an example structure of a glasses-type wearable device;

FIG. 11 is a diagram illustrating an example operation of a band-type wearable device;

FIG. 12 is a diagram illustrating an example operation of activating at least one function by obtaining biometric information, performed by a band-type wearable device;

FIG. 13 is a diagram illustrating an example structure of a band-type wearable device; and

FIGS. 14 and 15 are block diagrams illustrating an example wearable device.

### DETAILED DESCRIPTION

Reference will now be made in greater detail to example embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are simply described below, by referring to the figures, to explain various aspects. As used herein, the term “and/or” includes any and all combinations of one or more of the associated listed items. Expressions such as “at least one of,” when preceding a list of elements, modify the entire list of elements and do not modify the individual elements of the list.

Throughout this disclosure, when an element is referred to as being “connected” to another element, it could mean that the element is “directly connected” to the other element, or the element and the other element are “electrically connected” having one or more elements between them. Also, when an element is referred to as “including” a component, unless specified otherwise, it does not mean that the element excludes any other component, but rather may refer to a situation in which the element may further include other components.

Throughout this disclosure, when data is referred to as being “output on the screen of a device,” it means that the data is displayed on the screen of the device. Therefore, data referred to as being “output on the screen of a device” is also “displayed on the screen of the device.”

Hereinafter, various example embodiments will be described in greater detail with reference to the accompanying drawings.

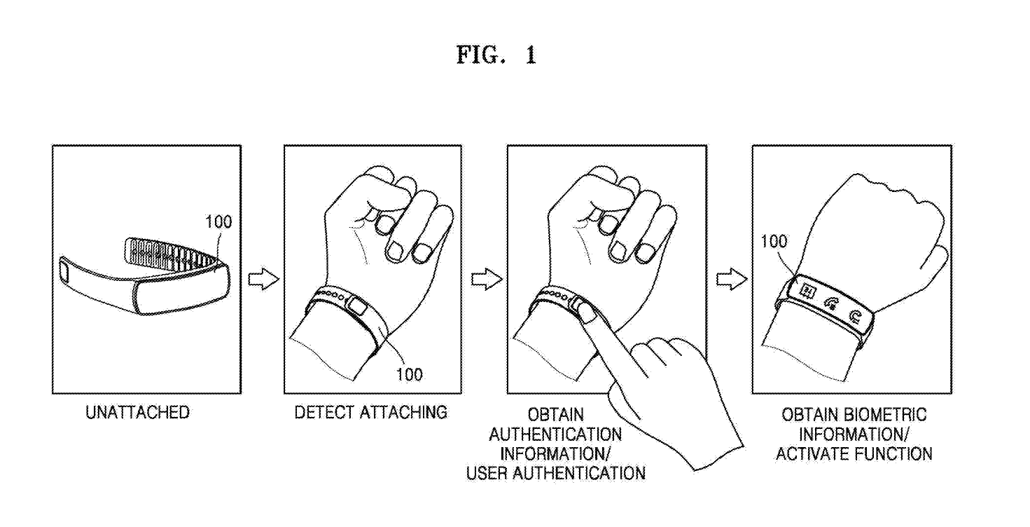

FIG. 1 is a diagram illustrating an example operation of a watch-type wearable device.

A “wearable device” is a device that may be attached to a user's body and may, for example, perform a computing operation. For example, the wearable device 100 may include various forms of wearable devices that may be attached to a user's body such as a watches, glasses, bands, bracelets, rings, necklaces, shoes, earphones, stickers, patches, clips, hats, shoes, or cloths, or the like.

The wearable device 100 may be configured to sense whether a user attaches or is wearing the wearable device 100 or not.

Referring to FIG. 1, for example, the watch-type wearable device 100 may sense a wearing state of the wearable device 100 based on whether a fastener located on a watch band is fastened or not.

For example, the fastener is a device for fixing a watch on a wrist. For example, the fastener may include a clasp, a buckle, ring, a button, a push button, or Velcro, or the like.

The wearable device 100 according to various example embodiments may enter a power saving mode and a stand-by mode for saving power when a user does not wear the wearable device 100. For example, the wearable device 100 in the power saving mode and the stand-by mode may partially restrict a function such as turning off a display, reducing brightness of the display, or restricting processor performance or a wireless communication function. Meanwhile, the wearable device 100 may leave the power saving mode and the stand-by mode when a user attaches the wearable device 100. Therefore, the wearable device 100 according to various example embodiments may save power by sensing whether a user attaches the wearable device 100.

For example, the watch-type wearable device 100 may leave the power saving mode and the stand-by mode when the fastener is fastened. Furthermore, the watch-type wearable device 100 may output a current time on a display of the device when the watch-type wearable device 100 leaves the power saving mode and enters the stand-by mode.

The wearable device 100 may obtain authentication information of a user. The wearable device 100 according to various example embodiments may obtain the authentication information of the user after being attached to the user. For example, not being in the stand-by mode may be a condition for obtaining the authentication information of the user for the wearable device 100.

“Authentication information” may, for example, refer to information for identifying (e.g., authenticating) the user of the wearable device 100. For example, the authentication information of the user may, for example, refer to information about at least one of the user's fingerprints, voice, iris, retina, vein, skeleton, and face, or the like.

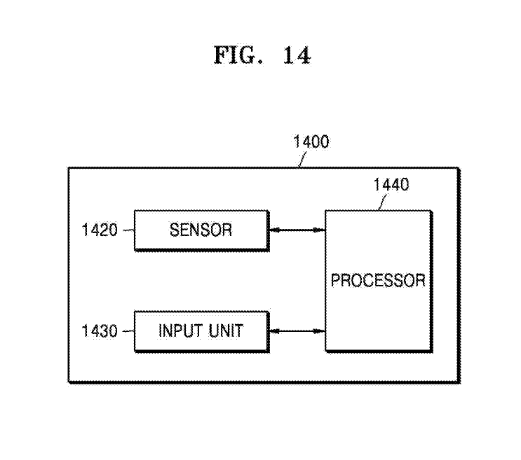

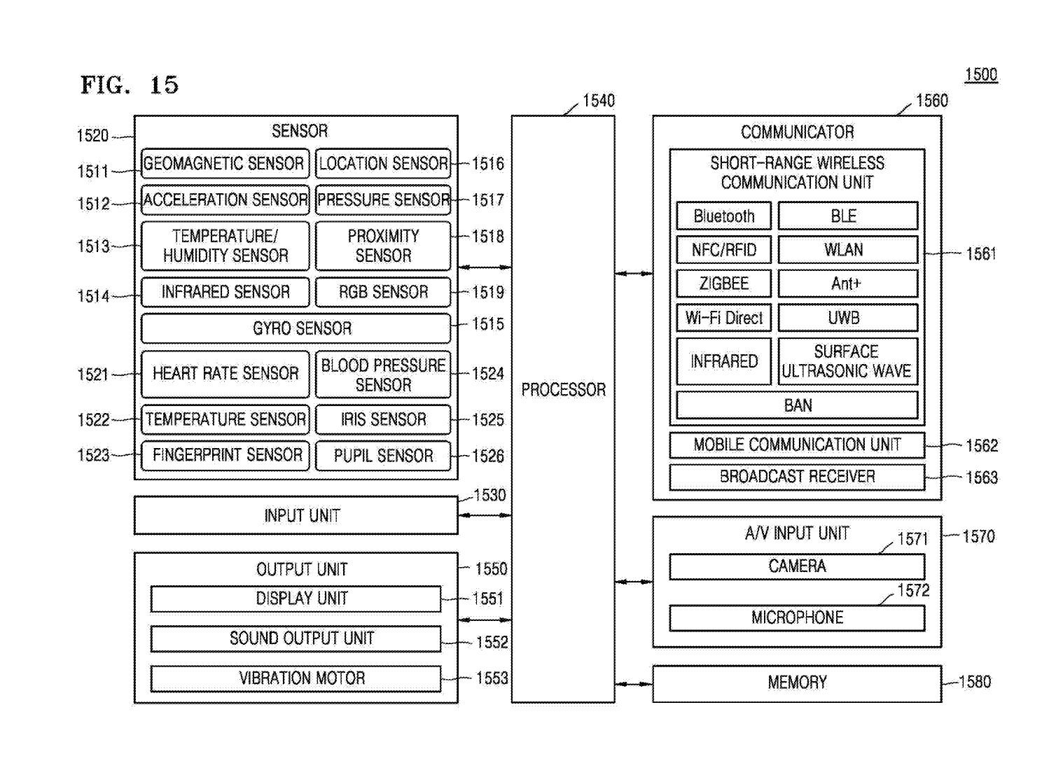

For example, the wearable device 100 may obtain information about fingerprints and irises of a user through sensors 1420 and 1520 (see, e.g., FIGS. 14 and 15). However, a method of obtaining biometric information of a user for the wearable device 100 is not limited thereto. For example, the wearable device 100, in order to obtain authentication information, may obtain information about a user's iris through a camera included in an audio/video (A/V) input unit 1570, or may obtain information about user's voice through a microphone 1572 included in the A/V input unit 1570 (see, e.g., FIG. 15).

For example, referring to FIG. 1, the watch-type wearable device 100 may obtain information about fingerprints as authentication information. For example, if a user touches a fingerprint sensor on the watch-type wearable device 100 with a finger, the watch-type wearable device 100 may obtain information about the user's fingerprints.

The wearable device 100 obtains at least one piece of biometric information of the user. The wearable device 100 according to various example embodiments may obtain biometric information of the user after authenticating the user. For example, authenticating the user may be a condition for obtaining the biometric information of the user for the wearable device 100.

Furthermore, “biometric information” may include, for example, at least one of information about a heart rate, an electrocardiography (ECG), a pulse, blood pressure, a temperature, an iris, sweat, eyes, an ultraviolet ray index, a retina, an artery, a vein, a skeleton, a face, and a motion of a user, or the like. The biometric information obtained from the user may vary depending on a user's body part to which the wearable device 100 is attached or the type of a sensor included in the wearable device 100.

The authentication information and the biometric information may include, for example, identical information. For example, information about an iris may be biometric information for identifying a user of the wearable device 100 and simultaneously may be biometric information for activating at least one function of the wearable device 100. The authentication information and the biometric information may not be exclusively related to each other based on a realizing method of the wearable device 100.

For example, referring to FIG. 1, the watch-type wearable device 100 may obtain at least one of biometric information about the heart rate, pulse, ECG, motion, sweat, blood pressure, and temperature from the wrist. For example, the watch-type wearable device 100 may obtain biometric information of a user from an artery in the wrist.

The wearable device 100 may be configured to activate at least one function based on the obtained biometric information.

The expression “activates a function” may, for example, refer to executing a prescribed application installed in the wearable device 100 or turning on a prescribed function. For example, the wearable device 100 may activate at least one function from among turning on a wireless communication function or a push notification function, and executing a navigation application, a pedometer application, or a home network control application, or the like, based on the biometric information of the user.

A “wireless communication function” may refer, for example, to a function of wireless data communication between the wearable device 100 and a host device, and an external device or the wearable device 100 and a server. For example, the wireless communication function may include short-range communication, mobile communication, or broadcast receiving, etc. Furthermore, the short-range communication may include Bluetooth, Bluetooth low energy (BLE), a near field communication (NFC), a wireless local area network (WLAN) (Wi-Fi), Zigbee, infrared data association (IrDA) communication, Wi-Fi direct (WFD), an ultra-wideband (UWB), Ant+, ultrasonic waves communication, or a body area network (BAN), but is not limited thereto.

Furthermore, a “home network control function” may refer, for example, to a function of controlling a house environment through a home network, performed by the wearable device 100. For example, the wearable device 100 may be configured to control furniture or devices installed in a house such as air-conditioners, heaters, computers, TVs, telephones, or microwave ovens, or the like, through the home network.

The wearable device 100 may, for example, determine a user's state based on biometric information measured from a user. For example, if a user's temperature is high and the pulse has quickened compared to in a user's normal state, the wearable device 100 may be configured to determine that the user is exercising and may execute applications related to exercising such as a pedometer application, a calorie-consumption measuring application, or a running-speed measuring application, or the like.

Furthermore, the wearable device 100 may be configured to determine whether the user has properly attached the wearable device 100 based on the biometric information measured from the user.

For example, the fastener may be fastened when the watch-type wearable device 100 is not attached to the user. In this example, power of the watch-type wearable device 100 may be wasted when prescribed functions are activated. Therefore, the watch-type wearable device 100, when the fastener is fastened, may activate the prescribed functions by determining whether the user has properly attached the wearable device 100 based on biometric information such as a pulse rate measured from a wrist.

For example, the watch-type wearable device 100, when a pulse rate measured from the wrist is 50 beats per minute or more, may be configured to determine that the user has properly attached the watch-type wearable device 100 and may activate the wireless communication function.

The wearable device 100 according to various example embodiments may be configured to obtain environment information of a user. Furthermore, the wearable device 100 according to various example embodiments may activate at least one function based on the biometric information and the environment information of the user.

“Environment information” may refer, for example, to information about an environment surrounding a user. For example, user environment information may include information about a position, weather, a temperature, humidity, brightness, and time, or the like.

The wearable device 100 may further be configured to accurately determine a user's state based on not only the biometric information measured from the user but also the environment information. For example, when a user's temperature is high, the pulse has quickened compared to in a user's normal state, and the user is located in an outdoor park, the wearable device 100 may be configured to determine that the user is exercising and may execute applications related to exercising.

The wearable device 100 according to various example embodiments may receive an input, the input setting a function to be activated based on the biometric information measured by the user (hereinafter, “a function to be activated based on the measured biometric information” may, for example, be abbreviated to “a function to be activated”). Furthermore, the wearable device 100 may set the function to be activated based on the received input.

Furthermore, the wearable device 100 according to various example embodiments may receive an input, the input setting a condition of the biometric information to activate the function of the wearable device 100 (hereinafter, “a condition of the biometric information to activate the function” may, for example, be abbreviated to “a condition of the biometric information”). Furthermore, the wearable device 100 may set the condition of the biometric information based on the received input.

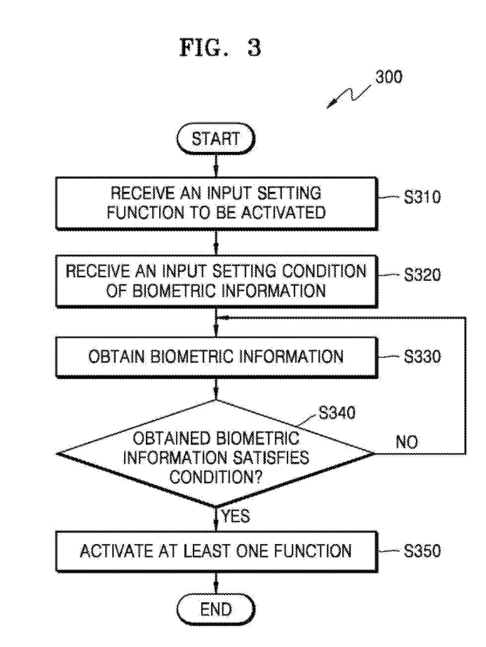

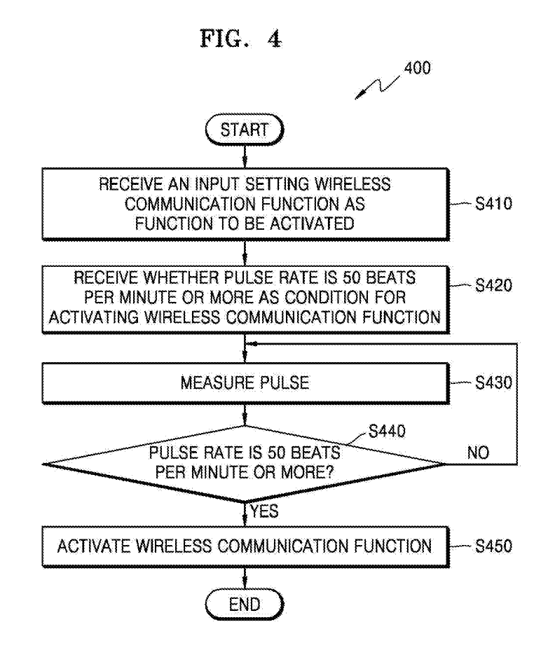

The operation of the wearable device 100 setting the function to be activated and the condition of the biometric information will be described in greater detail below with reference to FIGS. 3 to 4.

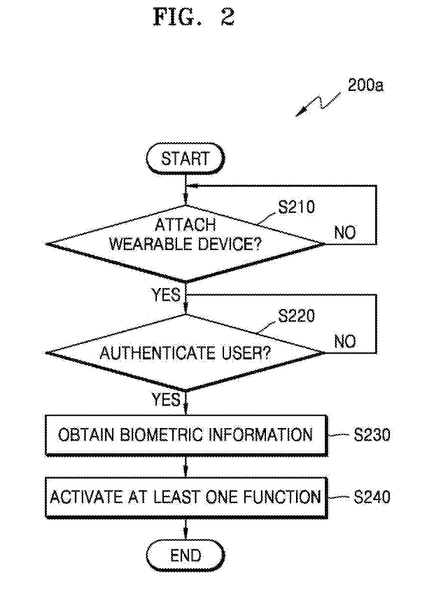

FIG. 2 is a flowchart 200 illustrating an example operation of a wearable device.

For example, FIG. 2 illustrates example steps in which the operation of the wearable device 100 of FIG. 1 may be processed time-sequentially. Therefore, the above-mentioned descriptions with respect to the operation of the wearable device 100 may also be applied to the example of FIG. 2 even if the descriptions are omitted below.

In operation S210, the wearable device may detect a wearing state of a user.

For example, the wearable device 100 may detect, through a first sensor including a pressure sensor, a proximity sensor, and a temperature sensor, or the like, whether the user has attached the wearable device 100.

In operation S220, if the wearable device detects that the user has attached the wearable device, the wearable device 100 may obtain authentication information of the user and may authenticate the user based on the obtained authentication information.

For example, the wearable device 100 may obtain authentication information of a user's fingerprints, iris, or voice, or the like, and may authenticate the user. For example, the wearable device 100 may authenticate the user by confirming whether the authentication information obtained from the user and authentication information registered in advance match each other.

The wearable device 100 according to various example embodiments may be configured to obtain the authentication information of the user through a second sensor which is activated when the wearable device 100 is attached in operation S210.

For example, it may, for example be assumed that the watch-type wearable device 100 senses whether or not the user has attached the watch-type wearable device 100 by fastening a fastener in operation S210. Therefore, in operation S220, a fingerprint sensor of the watch-type wearable device 100 may be activated. Furthermore, the watch-type wearable device 100 may authenticate the user by obtaining information about the user's fingerprints through the fingerprint sensor.

As described above, the wearable device 100 according to various example embodiments may save power by controlling power of a sensor for user authentication whether the user has attached the wearable device 100.

In operation S230, the wearable device 100 obtains biometric information of the user. The biometric information obtained from the user may vary depending on the type of the wearable device 100.

The wearable device 100 according to various example embodiments may obtain the biometric information of the user through a third sensor which is activated when the user is authenticated in operation S220.

For example, it may, for example, be assumed that the watch-type wearable device 100 authenticates the user through the fingerprint sensor in operation S220. Therefore, a pulse sensor of the watch-type wearable device 100 may be activated in operation S230. The watch-type wearable device 100 may measure a pulse of the user through the pulse sensor.

As described above, the wearable device 100 according to various example embodiments may save power by controlling power of a sensor for obtaining biometric information based on whether the user is authenticated.

Furthermore, in operation S230, the wearable device 100 according to various example embodiments may obtain environment information of the user.

The wearable device 100 according to various example embodiments may obtain the environment information of the user through a fourth sensor which is activated when the user is authenticated in operation S220.

For example, it may be assumed that the watch-type wearable device 100 authenticates the user through the fingerprint sensor in operation S220. Therefore, it is possible to obtain position information of the user as a global positioning system (GPS) of the watch-type wearable device 100 is activated in operation S230.

In operation S240, the wearable device 100 may activate at least one function based on the obtained biometric information. The function to be activated may, for example, be set by the user. Furthermore, the function to be activated may vary depending on the type of the wearable device 100, and the type and place of the biometric information obtained from the user.

For example, the watch-type wearable device 100 may activate a wireless communication function when a pulse rate measured from a wrist satisfies a prescribed condition.

Furthermore, in operation S240, the wearable device 100 according to various example embodiments may activate at least one function based on the biometric information and the environment information obtained in operation S230.

The wearable device 100 according to various example embodiments may provide convenience by activating at least one function based on the biometric information without a user's operation.

Furthermore, when at least one function of the wearable device 100 is activated in operation S240, at least one from among the first to third sensors of the wearable device 100 according to various example embodiments may be deactivated. For example, when at least one function of the wearable device 100 is activated in operation S240, the wearable device 100 may save power as the second sensor, which is a sensor for user authentication, is deactivated.

FIG. 3 is a flowchart 300 illustrating an example operation of setting a function to be activated in the wearable device 100 according to a condition of the biometric information.

For example, FIG. 3 illustrates an example in which the operation of the wearable device 100 of FIG. 1 may, for example, be processed time-sequentially. Therefore, the above-mentioned descriptions with respect to the operation of the wearable device 100 may be applied to the example of FIG. 3 even if the descriptions are omitted below.

In operation S310, the wearable device 100 may receive an input setting a function to be activated. For example, the wearable device 100 may select the function to be activated from among a plurality of functions included in the wearable device 100 without a user's operation, based on biometric information obtained from a user. For example, the wearable device 100 may set functions such as a wireless communication function and a push notification function, or the like, as a function to be activated based on the biometric information.

Furthermore, the wearable device 100 may set the function to be activated by reflecting the type of the wearable device 100 in operation S310. For example, a function included in the wearable device 100 or a specified function may vary depending on the type of wearable device 100. Therefore, the function to be activated based on the biometric information in the wearable device 100 may be variously set depending on the type of the wearable device 100.

In operation S320, the wearable device 100 may receive an input setting a condition of the biometric information to activate the function set in operation S310. For example, the wearable device 100 may respectively set an activation condition with respect to each function.

For example, a condition of the biometric information to activate at least one function may include whether a value of the biometric information is included in a prescribed range. For example, the wearable device 100 may set a pulse rate measured from the user to be 50 beats per minute or more as a condition for activating the wireless communication function.

Furthermore, the condition of the biometric information to activate at least one function may be set based on, for example, a user's constitution. A biometric information feature of the user such as blood pressure, a pulse, and a temperature may be different from a biometric information feature of other people depending on a constitution such as height, weight, age, sex, race, medical history, and the like. Therefore, the wearable device 100 may set a condition of the biometric information based on the user's constitution.

For example, it may be assumed that the wireless communication function of the wearable device 100 is activated when blood pressure measured from the user exceeds a prescribed threshold. The wearable device 100 may set a threshold of a user having low blood pressure lower than a threshold of a user not having low blood pressure. For example, the wearable device 100 may correct the condition of the biometric information by inputting information about a user's constitution.

Furthermore, the wearable device 100 may activate various functions depending on the biometric information obtained from the user. For example, even in the case of the same user, a value of the biometric information such as blood pressure, a pulse, and temperature may change based on a user's body state due to hormone effects. Therefore, the biometric information obtained from the user may be information about the user's body state, and the wearable device 100 may activate functions suitable for the user's body state based on the obtained biometric information.

For example, it may be assumed that the push notification function is activated or restricted based on the pulse rate measured from the user. When the pulse rate of the user is 90 beats per minute or more, the wearable device 100 determines that the user is exercising and may entirely or partially restrict the push notification function. For example, when the pulse rate measured from the user is 90 beats per minute or more, the push notification function of the wearable device 100 may be activated with respect to only messages, email, and phone calls received from family members and colleagues.

FIG. 3 illustrates that the wearable device 100 according to various example embodiments performs operation S310 prior to operation S320; however, the wearable device 100 according to another example embodiment may perform operation S320 before operation S310. For example, the wearable device 100 may set a function to be activated after setting a condition of the biometric information.

In operation S330, the wearable device 100 obtains biometric information. As operation S330 may be the same as operation S230, repeated descriptions of FIG. 2 are omitted.

In operation S340, the wearable device 100 may determine whether the biometric information of the user obtained in operation S330 satisfies the prescribed condition set in operation S320.

In operation S350, when the biometric information of the user satisfies the prescribed condition, the wearable device 100 activates at least one function. As operation S350 may be the same as operation S240, repeated descriptions of FIG. 2 are omitted.

FIG. 4 is a flowchart illustrating an example operation of activating a wireless communication function by obtaining a pulse of a user, performed by a wearable device.

For example, FIG. 4 illustrates steps in which the operation of the wearable device 100 of FIG. 1 may, for example, be processed time-sequentially. Therefore, the above-mentioned descriptions with respect to the operation of the wearable device 100 may be applied to the example of FIG. 4 even if the descriptions are omitted below.

In operation S410, the wearable device 100 may receive an input setting the wireless communication function as a function to be activated based on biometric information of a user.

Furthermore, in operation S420, the wearable device 100 may, for example, receive whether the pulse rate is 50 beats per minute or more as a condition for activating the wireless communication function.

In operation S430, the wearable device 100 may measure the pulse of the user. For example, a watch-type wearable device may measure the pulse from an artery of a wrist.

In operation S440, the wearable device 100 determines whether the pulse rate measured from the user to be 50 beats per minute or more.

As a result of the determination in operation S440, the wearable device may activate the wireless communication function in operation S450 when the pulse rate measured from the user to be 50 beats per minute or more.

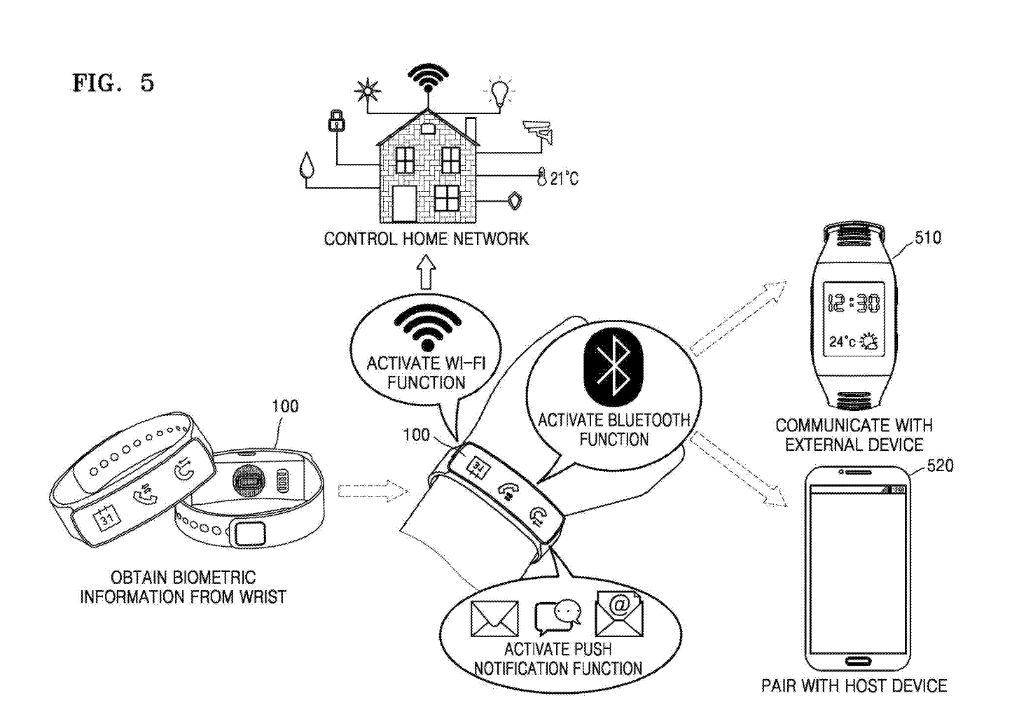

FIG. 5 is a diagram illustrating an example operation of activating at least one function by obtaining biometric information, performed by a watch-type wearable device 100.

As described above in FIG. 1, the watch-type wearable device 100 of FIG. 5 may detect a wearing state of the wearable device 100 based, for example, on whether a fastener is fastened or not.

Furthermore, the watch-type wearable device 100 may obtain biometric information of a user by measuring a pulse of a wrist. Furthermore, the watch-type wearable device 100 may activate a Wi-Fi function, a Bluetooth function, and a push notification function when the pulse rate measured from the wrist is 50 beats per minute or more. For example, the watch-type wearable device 100 may determine that a user properly attaches the watch-type wearable device 100 when the pulse rate measured from the wrist is 50 beats per minute or more. Therefore, the watch-type wearable device 100 may activate a wireless communication function and the push notification function.

Furthermore, the watch-type wearable device 100 having the activated Bluetooth function may be paired with a host device 520 and an external device 510.

The “host device 520” may refer, for example, to a device capable of controlling the wearable device 100. For example, the host device 520 may install a prescribed application for controlling the wearable device 100. Furthermore, the wearable device 100 may include a prescribed widget corresponding to the prescribed application installed in the host device 520. The host device 520 may execute the prescribed application and may command to transmit/receive prescribed data to/from the wearable device 100, or to perform a prescribed operation for the wearable device 100. For example, the host device 520 may control the wearable device 100 to output a notification signal.

The wearable device 100 may also control the host device 520. For example, the wearable device 100 may install a prescribed widget to control the host device 520. Furthermore, the host device 520 may install a prescribed application corresponding to the prescribed widget installed in the wearable device 100. The wearable device 100 may execute the prescribed widget and may execute a command to transmit/receive prescribed data to/from the host device 520, or to perform a prescribed operation for the host device 520. For example, the wearable device 100 may request the host device 520 for current time information.

The host device 520 may be realized in various forms such as smart phones, tablet PCs, and computers, or the like. Furthermore, in general, the user of the wearable device 100 and the user of the host device 520 are typically the same.

The wearable device 100 may communicate with the host device 520. For example, the wearable device 100 may be paired with the host device 520 and may transmit/receive data to/from the host device 520. The wearable device 100 may undergo authenticating and registering processes to be paired with the host device 520.

For example, the wearable device 100 may communicate with the host device 520 using a wired/wireless communication method. For example, the wearable device 100 may communicate with the host device 520 through a data cable connected to the host device 520. Furthermore, the wearable device 100 may communicate with the host device 520 using a wireless communication method such as NFC, Zigbee, Bluetooth, or UWB communication, or the like.

Furthermore, the “external device 510” may refer, for example, to a device capable of communicating with the wearable device 100 other than the host device 520. The external device 510 may, for example, be realized in various forms such as wearable devices, smart phones, tablet PCs, or computers, or the like. The wearable device 100 may communicate with the external device 510 using the same wired/wireless communication method as the communication method used with the host device 520.

Furthermore, the watch-type wearable device 100 having the activated wireless communication function may activate a home network control function. For example, the watch-type wearable device 100 may activate the home network control function when the wireless communication function according to Wi-Fi, Bluetooth or a mobile communication network is activated.

For example, when the wireless communication function is activated, the watch-type wearable device 100 may obtain list information of at least one device capable of being controlled by the wearable device 100 through a home network, from a server connected to the home network. Furthermore, the watch-type wearable device 100 may display the list information obtained from the server on a display and may receive an input selecting a device to control from among the displayed list. Therefore, the watch-type wearable device 100 may execute an application to control the selected device.

For example, the watch-type wearable device 100 may restrict some of push notifications when a pulse rate measured from a wrist is 90 beats per minute or more. For example, when a pulse rate measured from the wrist is 90 beats per minute or more, the wearable device 100 may determine that the user is exercising. Therefore, the watch-type wearable device 100 may activate a push notification function of an urgent message or email, and may restrict a commercial push notification function with respect to a shopping application or a spam message.

For example, the watch-type wearable device 100 may activate an application related to health care such as a heart rate diagnostic application when the pulse rate measured from a wrist is less than 40 beats per minute or 120 beats per minute or more. For example, when the pulse rate measured from a wrist exceeds a prescribed range, the watch-type wearable device 100 may determine that the user's heart is functioning abnormally and may execute an application for self-diagnosis. Furthermore, when the pulse rate measured from the wrist exceeds a normal range, the watch-type wearable device 100 may generate an alarm sound or output a warning message to the display.

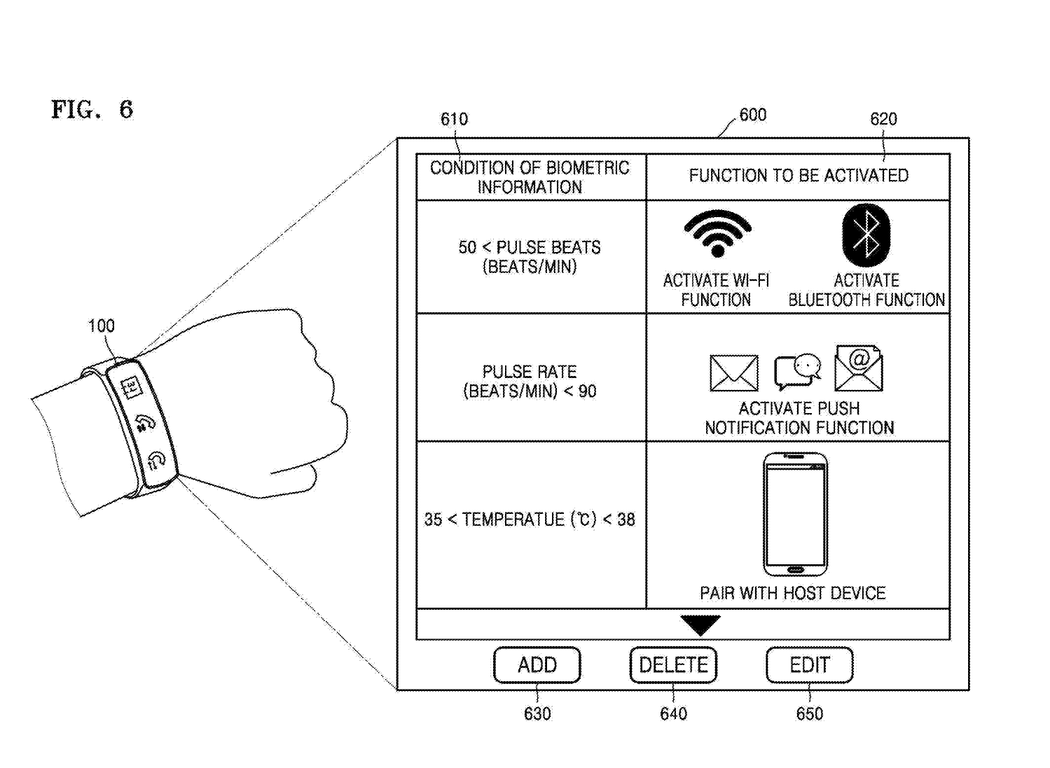

FIG. 6 is a diagram illustrating an example operation of setting a function 620 to be activated in a watch-type wearable device and a condition 610 of biometric information.

A watch-type wearable device 100 according to various example embodiments, through a prescribed user interface display 600, may receive an input setting the function 620 to be activated based on the biometric information, or may receive an input setting the condition 610 of the biometric information to activate a prescribed function.

For example, the user interface display 600 may include at least one from among an add button 630, a delete button 640, and an edit button 650 for the condition 610 of the biometric information and the function 620 to be activated.

For example, the watch-type wearable device 100 may set a Wi-Fi function, a Bluetooth function, a push notification activation function, and a pairing function as a function to be activated.

Furthermore, the watch-type wearable device 100 may set a pulse rate measured from a wrist to exceed 50 beats per minute as an activation condition of the Wi-Fi function and the Bluetooth function, a pulse rate measured from a wrist to be less than 90 beats per minute as an activation condition of the push notification function, and a temperature measured from a wrist to exceed 35° C. and to be less than 38° C. as a condition for pairing with a host device.

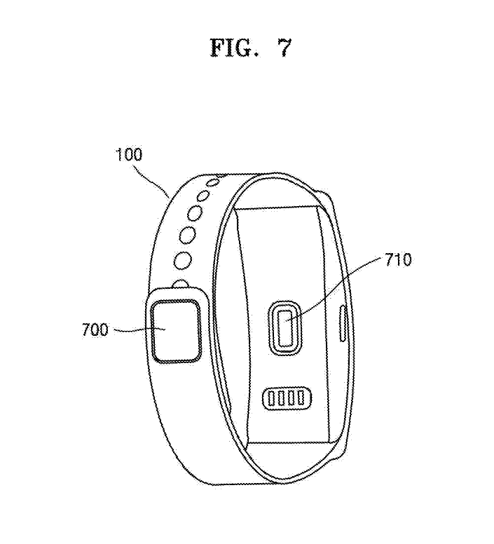

FIG. 7 is a diagram illustrating an example structure of a watch-type wearable device 100.

For example, as illustrated in FIG. 7, the watch-type wearable device 100 may include a fastener 700 in the form of a ring or a clasp. A first sensor (not shown) of the watch-type wearable device 100 may be located on the fastener 700 and may detect a wearing state of the wearable device 100 based on whether the fastener is fastened or not.

Furthermore, a second sensor (not shown) of the watch-type wearable device 100 may be located on the fastener 700 and may obtain, for example, fingerprint information as authentication information of a user.

Furthermore, a third sensor 710 of the watch-type wearable device 100 may measure biometric information. For example, the third sensor 710 may be located on a rear surface of the watch and may measure biometric information such as blood pressure, a pulse, and a temperature from a wrist.

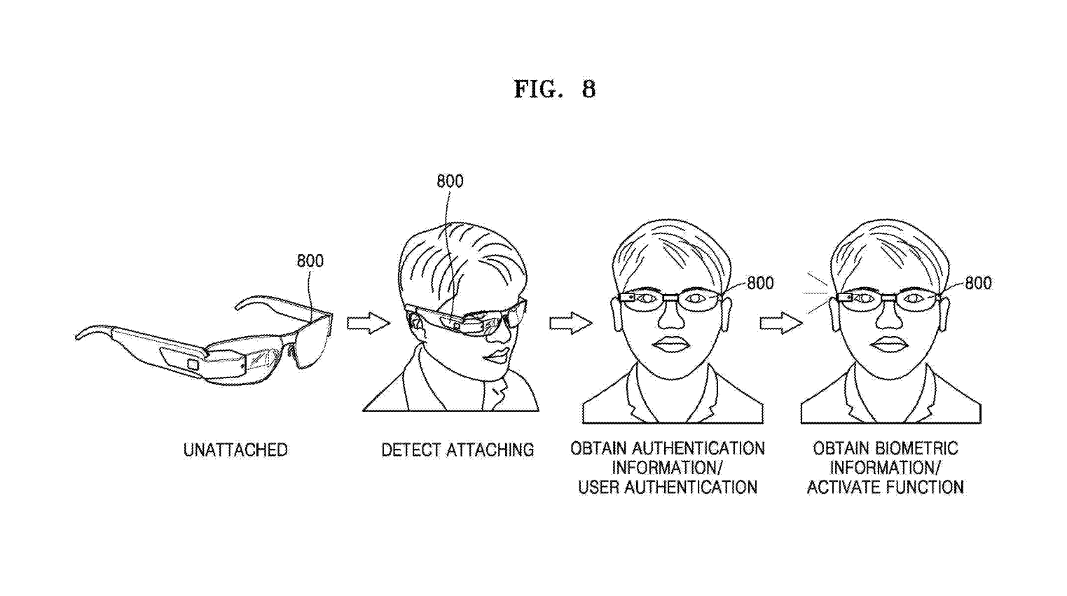

FIG. 8 is a diagram illustrating an example operation of a glasses-type wearable device 800.

The glasses-type wearable device 800 may sense a wearing state of the glasses-type wearable device 800 based on at least one of, for example, pressure applied to the glasses-type wearable device 800 and an angle between a rim and a temple.

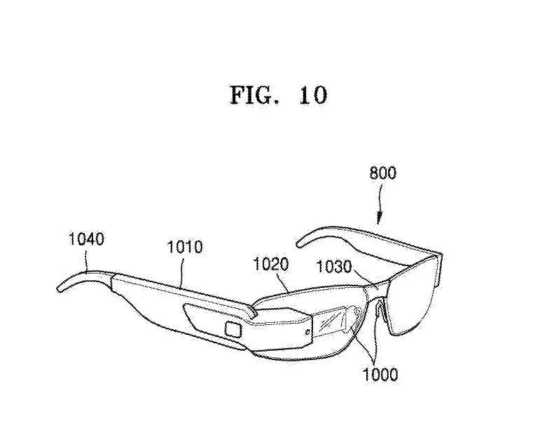

“Pressure applied to the glasses-type wearable device 800” may refer, for example to pressure generated between a user's face and the glasses-type wearable device 800 when the user attaches the glasses-type wearable device 800. For example, the pressure applied to the glasses-type wearable device 800 may include at least one of pressures generated between nose pads 1000 of the glasses, a temple 1010, a bridge 1030, a rim 1020, or a tip 1040 and the user's face or head (see FIG. 10).

For example, the pressure applied to the nose pads 1000 may, for example, be pressure generated between a ridge of the nose and the nose pads 1000.

Furthermore, the pressure applied to the temple 1010 may, for example, be pressure generated between a user's temple and the temple 1010 of the glasses. The temple 1010 of the glasses may be a component of the glasses connecting the rim 1020 and the tip 1040 and may be distinguished from the user's temple.

Furthermore, the pressure applied to bridge 1030 may be pressure generated between the ridge of the nose and the bridge 1030. The bridge 1030 is a component of the glasses connecting the rim 1020 and the rim 1020.

Furthermore, the pressure applied to the rim 1020 may be pressure generated between a cheekbone and the rim 1020. The rim 1020 is a component of the glasses in which glasses lenses are installed.

Furthermore, the pressure applied to the tip 1040 may be pressure generated between an ear and the tip 1040. The tip 1040 is a component of the glasses hooking around the user's ear.

For example, an attachment of the glasses-type wearable device 800 is sensed when pressure applied to the nose pads exceeds a first threshold or pressure applied to the temple exceeds a second threshold, and the glasses-type wearable device 800 may leave a power saving mode and a stand-by mode.

For example, an attachment of the glasses-type wearable device 800 is sensed when an angle between respective extension lines of the rim 1020 and the temple 1010 is 45° or more, and the glasses-type wearable device 800 may leave a power saving mode and a stand-by mode.

For example, current position information and time information may be output on lenses of the glasses-type wearable device 100 when the attachment of the glasses-type wearable device 800 is sensed.

As described above, biometric information measured from a user may vary depending on the type of a wearable device. For example, the glasses-type wearable device 800 may measure at least one piece of biometric information of a pulse and blood pressure from a user's temple. For example, the glasses-type wearable device 800 may measure the pulse and blood pressure from an artery in the user's temple.

The glasses-type wearable device 800 may, for example, obtain information about a user's gaze, iris, and pupil besides the pulse and blood pressure measured from the user's temple.

The glasses-type wearable device 800 may activate at least one function based on the pulse rate measured from the user's temple. For example, when the pulse rate measured from the user's temple is 50 beats per minute or more, the glasses-type wearable device 800 may determine that the user has properly attached the glasses-type wearable device 800 and may activate a wireless communication function.

For example, an angle between the rim 1020 and the temple 1010 may be 45° or more or pressure having the first threshold or more may be applied to the nose pads 1000 when the glasses-type wearable device 800 is not attached to a user. In this example, power of the glasses-type wearable device 800 may be wasted when prescribed functions are activated. Therefore, the glasses-type wearable device 800 may determine whether the glasses are properly attached based on the biometric information measured from the user's temple. For example, when the pulse rate measured from the user's temple is 50 beats per minute or more, the glasses-type wearable device 800 may determine that the user has properly attached the glasses-type wearable device 800 and may activate the wireless communication function.

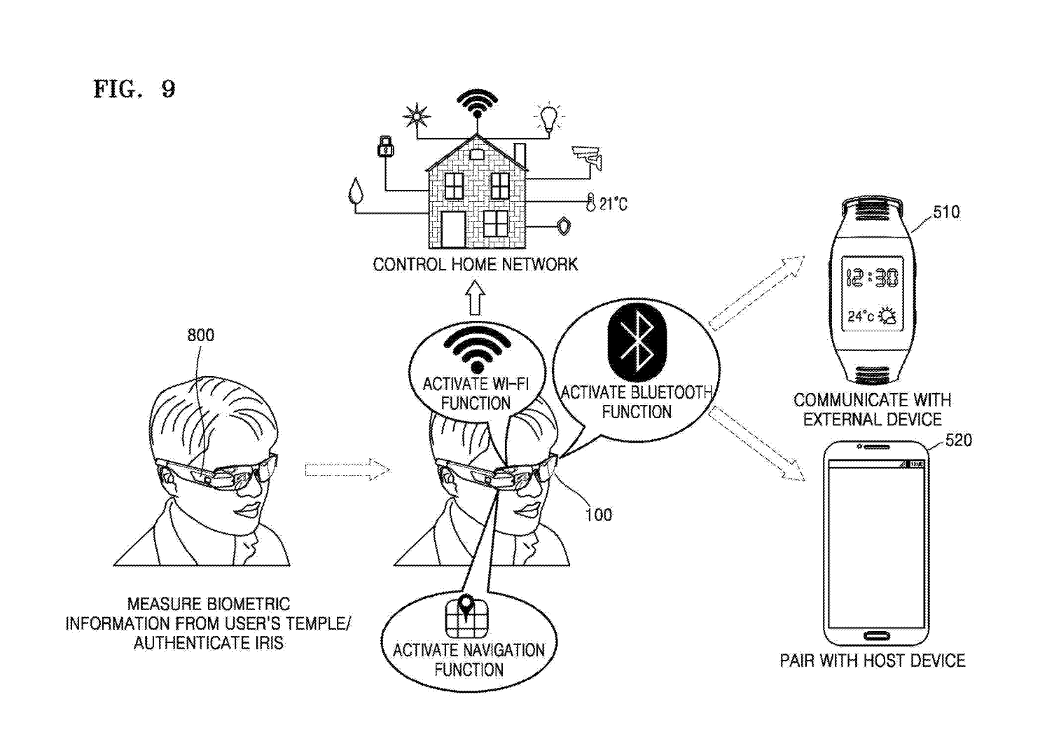

FIG. 9 is a diagram illustrating an example operation of activating at least one function by obtaining biometric information, performed by a glasses-type wearable device 800.

The glasses-type wearable device 800 may measure a pulse of a user's temple. Furthermore, when a pulse rate measured from a user's temple is 50 beats per minute or more, the glasses-type wearable device 800 may activate a Wi-Fi function, a Bluetooth function, and a push notification function.

Furthermore, the glasses-type wearable device 800 having the activated wireless communication functions may pair with a host device 520 and an external device 510 and may activate a home network control function.

As described above, functions or a specified function included in a wearable device may vary depending on the type of the wearable device. For example, the glasses-type wearable device 800 may specify a display function such as a navigation system and an augmented reality system compared to different types of wearable devices. Therefore, the glasses-type wearable device 800 may activate the navigation function when the pulse rate measured from the user's temple is 50 beats per minute or more.

For example, the glasses-type wearable device 800 may activate a light function by sensing that a user's pupil becomes smaller. For example, the glasses-type wearable device 800 may determine that the user moved from a bright area to a dark area by sensing that the user's pupil becomes smaller, and may execute a light application.

FIG. 10 is a diagram illustrating an example structure of a glasses-type wearable device.

For example, a first sensor (not shown) located in nose pads 1000 may measure pressure applied to the nose pads 1000 and may detect a wearing state of a glasses-type wearable device 800.

Furthermore, a second sensor (not shown) located on a rim 1020 of the glasses may obtain information about an iris as authentication information of a user.

Furthermore, a third sensor (not shown) located on a temple 1010 of the glasses may measure information about blood pressure and a pulse of a user's temple as biometric information of a user.

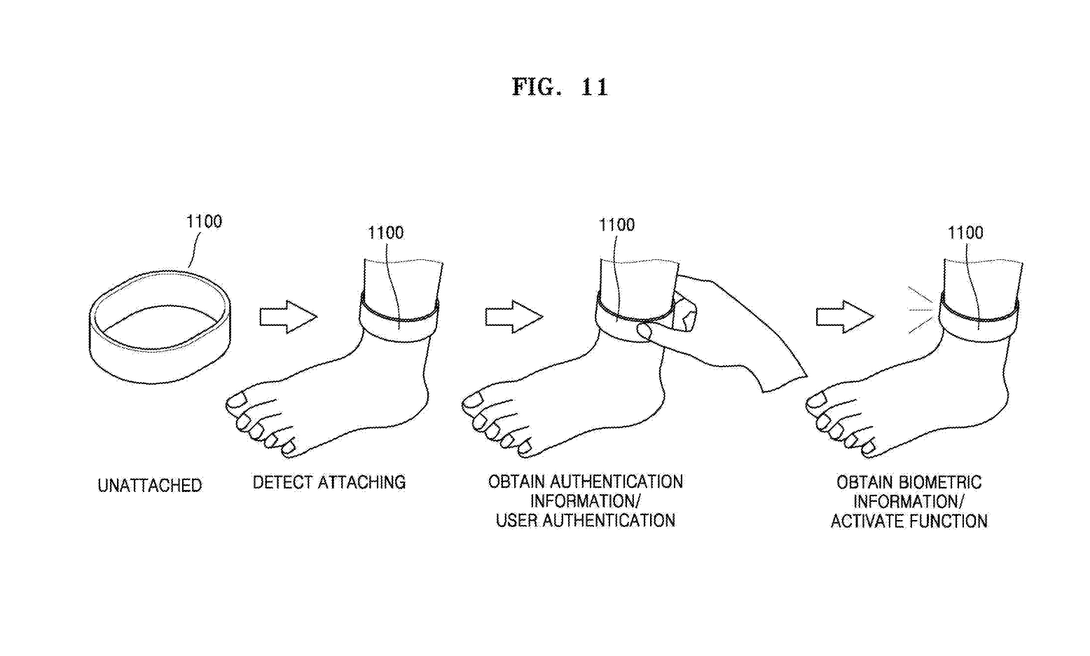

FIG. 11 is a diagram illustrating an example operation of a band-type wearable device according to an exemplary embodiment.

The “band-type wearable device” may refer, for example, to a device attachable to a user's body such as a head, an arm, a leg, a wrist, fingers, an ankle, and toes, or the like, using, for example, an elastic band.

When a band-type wearable device 1100 is attached to a wrist or an ankle, the band may be stretched by pressure generated between a user and the band. Therefore, the band-type wearable device 1100 may detect a wearing state of the band-type wearable device 1100 based on the pressure applied to the band. The band-type wearable device 1100 may detect the wearing state of the band-type wearable device 100 based on a transformed shape of the band or elasticity of the band as well as or instead of the pressure.

For example, when the pressure applied to the band exceeds a prescribed threshold, the band-type wearable device 1100 may sense the wearing state of the band-type wearable device 1100 and may leave a power saving mode and a stand-by mode.

As described above, biometric information obtained from a user may vary depending on the type of a wearable device. The band-type wearable device 1100 may measure at least one of blood pressure, a pulse, and a temperature from a body part to which a band is contacted. For example, when a user attaches the band-type wearable device 1100 to the ankle, the band-type wearable device 1100 may measure a pulse from an artery of the ankle.

The band-type wearable device 1100 may activate at least one function based on the biometric information obtained from the body part to which the band is contacted. For example, when the band-type wearable device 1100 is attached to an ankle and the pulse rate measured from the user's ankle is 50 beats per minute or more, the band-type wearable device 1100 may determine that the user has properly attached the band-type wearable device 1100 and may activate a wireless communication function.

For example, pressure may be applied to the band when the band-type wearable device 100 is not attached to the user. In this example, power of the band-type wearable device 1100 may be wasted when prescribed functions are activated. Therefore, the wearable device 1100 may determine whether the user has properly attached the band based on the biometric information of the user. For example, when the pulse rate measured from the ankle is 50 beats per minute or more, the band-type wearable device 1100 may determine that the user has properly attached the band-type wearable device 1100 and may activate the wireless communication function.

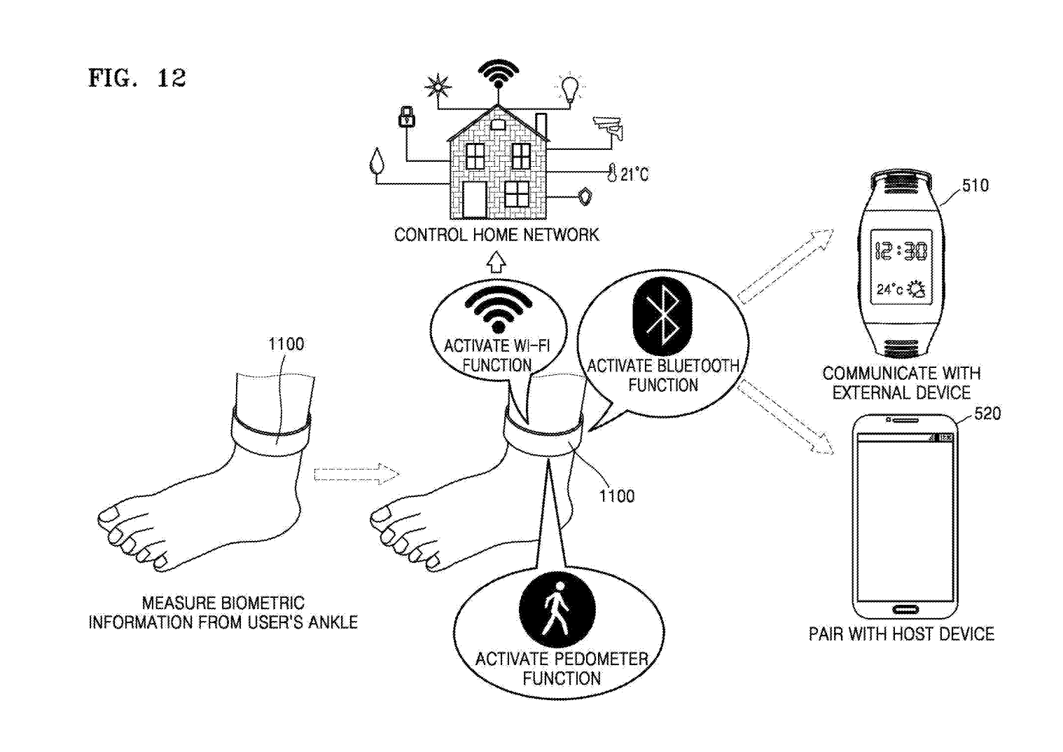

FIG. 12 is a diagram illustrating an example operation of activating at least one function by obtaining biometric information, performed by a band-type wearable device 1100.

Referring to FIG. 12, when the band-type wearable device 1100 is attached to a user's ankle, the band-type wearable device 1100 may measure a pulse from the ankle. Furthermore, when the pulse rate measured from the ankle is 50 beats per minute or more, the band-type wearable device 1100 may activate a Wi-Fi function, a Bluetooth function, and a push notification function.

Furthermore, the band-type wearable device 1100 having the activated wireless communication functions may pair with a host device 520 and an external device 510 and may activate a home network control function.

For example, the band-type wearable device 1100 may measure moving speed of a user as biometric information and may execute a pedometer application. For example, when the moving speed of the user exceeds a prescribed threshold, the band-type wearable device 1100 determines that the user is exercising and may execute the pedometer application.

The methods described above may be written as a program executable in a computer, and may be implemented by a general-use digital computer that runs the program stored, for example, in a non-transitory computer-readable recording medium. The structure of data used in the methods described above may be recorded in non-transitory computer-readable recording media in several ways. The non-transitory computer-readable recording media include storage media, such as magnetic storage media (e.g., a read-only memory (ROM), a random access memory (RAM), a universal serial bus (USB) memory, a floppy disk, a hard disk, etc.) and optical reading media (e.g., a compact disc (CD)-ROM, a digital versatile disc (DVD), etc.).

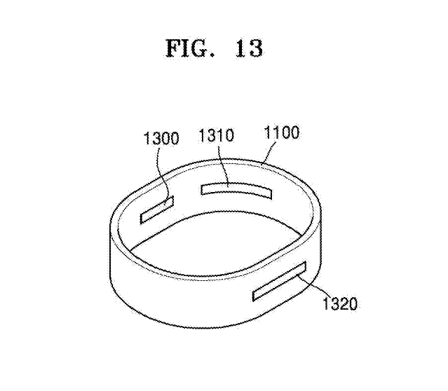

FIG. 13 is a diagram illustrating an example structure of a band-type wearable device.

For example, a first sensor 1300 located on an inner surface of the band may measure pressure between the band and a user and may detect a wearing state of a band-type wearable device 1100.

Furthermore, a second sensor 1320 located on an outer surface of the band may obtain information about fingerprints as authentication information of the user.

Furthermore, a third sensor 1310 located on the inner surface of the band may obtain information about blood pressure, a pulse, and a temperature of a body part to which the band is contacted as biometric information of the user.

FIGS. 14 to 15 are block diagrams illustrating an example wearable device.

Devices 1400 and 1500 illustrated in FIGS. 14 to 15 may correspond, for example, to the watch-type wearable device 100, the glasses-type wearable device 800, and the band-type wearable device 1100 described above with reference to FIGS. 1 to 14.

Referring to FIG. 14, the wearable device 1400 according to various example embodiments may include a sensor (e.g., including at least one sensor including sensor circuitry) 1420 and a processor (e.g., including processing circuitry) 1440. Furthermore, the wearable device 1400 may further include an input unit (e.g., including input circuitry) 1430.

Furthermore, not all components of FIG. 14 are essential components of the wearable device 1400. The wearable device 1400 may also be realized by using more or fewer components than those of FIG. 14.

For example, referring to FIG. 15, a wearable device 1500 according to another example embodiment may further include an output unit (e.g., including output circuitry) 1550, a communicator (e.g., including communication circuitry/chips) 1560, an A/V input unit (e.g., including input circuitry) 1570, and a memory 1580 compared to the wearable device 1400 of FIG. 14.

The sensors 1420 and 1520 may sense a state of the devices 1400 and 1500 or a state around the devices 1400 and 1500, and a state of a user and a state around the user and may transmit the sensed information to processors 1440 and 1540.

The sensors 1420 and 1520 may include at least one of a geomagnetic sensor 1511, an acceleration sensor 1512, a temperature/humidity sensor 1513, an infrared sensor 1514, a gyro sensor 1515, a location sensor (e.g., GPS) 1516, a pressure sensor 1517, a proximity sensor 1518, an RGB (illuminance) sensor 1519, a heart rate sensor 1521, a temperature sensor 1522, a fingerprint sensor 1523, a blood pressure sensor 1524, an iris sensor 1525, and a pupil sensor 1526, but are not limited thereto. For example, the sensors 1420 and 1520 may further include a heart rate measurement sensor or an ECG sensor. Functions of the respective sensors may be intuitively inferred from their names by those of ordinary skill in the art, and thus detailed descriptions of the functions will be omitted.

For example, the sensors 1420 and 1520 may detect a wearing state of the wearable devices 1400 and 1500. Furthermore, the sensors 1420 and 1520 may obtain authentication information of a user, at least one piece of biometric information of a user, and at least one piece of environment information of a user.

The sensors 1420 and 1520 may be distinguished into a plurality of sensors depending on the function. For example, the sensors 1420 and 1520 may include a first sensor detecting the wearing state of the wearable devices 1400 and 1500, a second sensor obtaining the authentication information of the user, a third sensor obtaining the biometric information of the user, and a fourth sensor obtaining the environment information of the user.

Furthermore, the sensors 1420 and 1520 may be activated or deactivated based on the state of the wearable devices 1400 and 1500. For example, the first sensor detecting the wearing state of the wearable devices 1400 and 1500 may be always activated when the wearable devices 1400 and 1500 are turned on. The second sensor obtaining the authentication information of the user may be activated after the wearing state of the wearable devices 1400 and 1500 are detected by the first sensor. Furthermore, the third sensor obtaining the biometric information of the user and the fourth sensor obtaining the environment information of the user may be activated after the user is authenticated.

Furthermore, at least one of the first to fourth sensors may be deactivated when the wearable devices 1400 and 1500 activate a prescribed function based on the biometric information of the user, or based on the biometric information and the environment information of the user.

The processors 1440 and 1540 typically control general operations of the wearable devices 1400 and 1500. For example, the processors 1440 and 1540 may generally control power switch units 1410 and 1510, the sensors 1420 and 1520, input units 1430 and 1530, the output unit 1550, the communicator 1560, and the A/V input unit 1570 by executing programs stored in the memory 1580.

For example, when the wearing state of the wearable devices 1400 and 1500 is detected by the sensors 1420 and 1520, the processors 1440 and 1540 may authenticate the user based on the authentication information obtained by the sensors 1420 and 1520. Furthermore, the processors 1440 and 1540 may activate at least one function based on the biometric information obtained by the sensors 1420 and 1520. Furthermore, the processors 1440 and 1540 may activate at least one function based on the biometric information and the environment information obtained by the sensors 1420 and 1520.

The input units 1430 and 1530 are portions in which the user inputs data for controlling the wearable devices 1400 and 1500. For example, the input units 1430 and 1530 may be a key pad, a dome switch, a touchpad (a touch capacitive type, pressure resistive type, an infrared sensing type, a surface ultrasonic wave type, an integral tension measurement type, a piezo effect type, etc.), a jog wheel, a jog switch, etc., but are not limited thereto.

For example, the input units 1430 and 1530 may receive an input setting a function to be activated, and may receive an input setting a condition of the biometric information to activate the function.

The A/V input unit 1570 may be provided to input an audio signal or a video signal, and may include a camera 1571, a microphone 1572, and so on. The camera 1571 may obtain an image frame such as a still image or a moving image through an image sensor in a video call mode or a photographing mode. An image captured by the image sensor may be processed by the processors 1440 and 1540 or an image processor (not shown).

Furthermore, the A/V input unit 1570 may be included in the sensors 1420 and 1520 according to an example embodiment of the wearable devices 1400 and 1500.

The image frame processed by the camera 1571 may be stored in the memory 1580 or transmitted to the outside through communicator 1560. Two or more cameras 1571 may be provided based on a configuration of the wearable devices 1400 and 1500.

The microphone 1572 may receive an external sound signal and processes the external sound signal as electrical voice data. For example, the microphone 1572 may receive the external sound signal from the external device or a speaker. The microphone 1572 may use various noise removal algorithms for removing noise that is generated during the process of receiving the external sound signal.

The output unit (e.g., including output circuitry) 1550 may output an audio signal, a video signal, or a vibration signal, and include a display unit (e.g., including a display panel and display driving circuitry) 1551, a sound output unit (e.g., including sound output circuitry) 1552, and a vibration motor 1553.

The display unit 1551 outputs information processed by the wearable devices 1400 and 1500. For example, the display unit 1551 may display a user interface for selecting a virtual image, a user interface for setting an operation of a virtual image, and a user interface for purchasing an item of a virtual image.

When the display unit 1551 and a touchpad are layered and constitute a touch screen, the display unit 1551 may be used as an input device as well as an output device. The display unit 1551 may include at least one of a liquid crystal display (LCD), a thin film transistor-liquid crystal display (TFT-LCD), an organic light-emitting diode (OLED), a flexible display, a three-dimensional (3D) display, and an electrophoretic display, or the like. According to an example implementation, the wearable devices 1400 and 1500 may include two or more display units 1551. The two or more display units 1551 may be disposed to face each other by using a hinge.

The sound output unit 1552 outputs audio data received from the communicator 1560 or stored in the memory 1580. The sound output unit 1552 may output sound signals (e.g., a call signal receiving sound, a message receiving sound, a notification sound, etc.) associated with functions performed by the wearable devices 1400 and 1500. The sound output unit 1552 may include a speaker, a buzzer, and so on.

The vibration motor 1553 may output a vibration signal. For example, the vibration motor 1553 may output a vibration signal corresponding to an output of the audio data (e.g., the call signal receiving sound, the message receiving sound, etc.) or video data. Also, when a touch is input to the touch screen, the vibration motor 1553 may output a vibration signal.

The communicator 1560 may include one or more components that allow data communication between the wearable devices 1400 and 1500 and other devices or between the wearable devices 1400 and 1500 and a server. For example, the communicator 1560 may include a short-range wireless communication unit 1561, a mobile communication unit 1562, and a broadcast receiver 1563.

The short-range wireless communication unit 1561 may include a Bluetooth communicator, a BLE communicator, an NFC/radio frequency identification (RFID) unit, a WLAN (Wi-Fi) communicator, a ZigBee communicator, an infrared (IrDA) communicator, a WFD communicator, a UWB communicator, an Ant+ communicator, an infrared communicator, an ultrasonic communicator, a BAN communicator, etc., but is not limited thereto.

The mobile communicator 1562 may exchange wireless signals with at least one of a base station, an external terminal, and a server in a mobile communication network. For example, the wireless signal may include a voice call signal, a video call signal, or various forms of data according to transmission and reception of a text/multimedia message.

The broadcast receiver 1563 may receive a broadcast signal and/or broadcast-associated information from the outside through a broadcast channel. The broadcast channel may include a satellite channel and a terrestrial wave channel. According to an example, the wearable devices 1400 and 1500 may not include the broadcast receiver 1563.

For example, the communicator 1560 may communicate with the host device 520. Also, the communicator 1560 may communicate with the external device 510.

The memory 1580 may store a program for processing and controlling the processors 1440 and 1540 and store data that is input to or output from the wearable devices 1400 and 1500.

The memory 1580 may include at least one type of storage medium among a flash memory-type storage medium, a hard disk-type storage medium, a multimedia card micro-type storage medium, a card-type memory (e.g., a secure digital (SD) memory, an extreme digital (XD) memory, etc.), a RAM, a static RAM (SRAM), a ROM, an electrically erasable programmable ROM (EEPROM), a programmable ROM (PROM), a magnetic memory, a magnetic disc, and an optical disc, or the like.

For example, the memory 1580 may store a condition of biometric information to activate a prescribed function.

As described above, the wearable devices 1400 and 1500 may save power by controlling power based on whether the wearable devices 1400 and 1500 are attached or not. Furthermore, the wearable devices 1400 and 1500 may provide convenience to a user by activating at least one function based on the biometric information of the user.

It should be understood that the example embodiments described herein should be considered in a descriptive sense only and not for purposes of limitation. Descriptions of the features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. A wearable device comprising:
a sensor arrangement comprising one or more sensors, the sensor arrangement configured to detect a wearing state of a wearable device and to obtain authentication information of a user and at least one piece of biometric information based on the detected wearing state; and
a processor configured to authenticate the user based on the obtained authentication information based on the wearing state of the wearable device detected by the sensor arrangement, and configured to activate at least one function of the wearable device based on the obtained biometric information.

2. The wearable device of claim 1, wherein
the sensor arrangement is configured to obtain at least one piece of environment information of the user, and
the processor is configured to activate at least one function based on the obtained biometric information and the environment information.

3. The wearable device of claim 1, wherein the sensor arrangement comprises:
a first sensor configured to detect the wearing state of the wearable device;
a second sensor configured to obtain the authentication information, said second sensor being configured to be activated when the wearing state of the wearable device is detected and detects that the wearable device is being worn; and
a third sensor configured to obtain the biometric information, said third sensor being configured to be activated when the user is authenticated.

4. The wearable device of claim 3, wherein at least one of the first, second and third sensors is configured to be deactivated when the at least one function is activated.

5. The wearable device of claim 1, wherein the at least one function comprises a function of controlling a home network environment.

6. The wearable device of claim 1, further comprising:
an input unit comprising input circuitry, the input unit configured to receive an input, the input setting the at least one function to be activated.

7. The wearable device of claim 6, wherein the input unit is further configured to receive an input, the input setting a condition of the biometric information to activate the at least one function.

8. The wearable device of claim 1, wherein
the wearable device comprises a watch-type wearable device, and
the sensor arrangement is configured to detect a wearing state of the watch-type wearable device based on whether a fastener located on a watch band is fastened.

9. The wearable device of claim 1, wherein
the wearable device comprises a glasses-type wearable device, and
the sensor arrangement is configured to detect a wearing state of the glasses-type wearable device based on at least one of: pressure applied to nose pads, a temple, a bridge, a rim, and a tip of the glasses-type wearable device, and angles between the rim and the temple.

10. The wearable device of claim 1, wherein
the wearable device comprises a band-type wearable device, and
the sensor arrangement is configured to detect a wearing state of the band-type wearable device based on pressure applied to a band.

11. A method of operating a wearable device comprising:
detecting a wearing state of a wearable device;
obtaining authentication information of a user and authenticating the user based on the detected wearing state of the wearable device;
obtaining at least one piece of biometric information of the user when the user is authenticated; and
activating at least one function of the wearable device based on the obtained biometric information.

12. The method of claim 11, further comprising:
obtaining at least one piece of environment information of the user, and
the activating of the at least one function comprises activating the at least one function based on the obtained biometric information and the environment information.

13. The method of claim 11, wherein the at least one function comprises a function of controlling a home network environment.

14. The method of claim 11, further comprising:
receiving an input setting the at least one function to be activated.

15. The method of claim 14, further comprising:
receiving an input setting a condition of the biometric information to activate the at least one function.

16. The method of claim 11, wherein
the wearable device comprises a watch-type wearable device, and
the detecting of the wearing state of the wearable device comprises detecting a wearing state of the watch-type wearable device based on whether a fastener located on a watch band is fastened.

17. The method of claim 11, wherein
the wearable device comprises a glasses-type wearable device, and
the detecting the wearing state of the wearable device comprises detecting a wearing state of the glasses-type wearable device based on at least one of: pressure applied to nose pads, a temple, a bridge, a rim, and a tip of the glasses-type wearable device, and angles between the rim and the temple.

18. The method of claim 11, wherein
the wearable device comprises a band-type wearable device, and
the detecting of the wearing state of the wearable device comprises detecting a wearing state of the band-type wearable device based on pressure applied to a band.

19. A non-transitory computer-readable recording medium having recorded thereon a program which, when executed, causes processing circuitry to control the wearable device to perform operations comprising the method of claim 11.
